(19) United States
(12) Patent Application Publication
(10) Pub. No.: US 2007/0041268 A1
(43) Pub. Date: Feb. 22, 2007

(54) Beverage mixer with spigot and actuator

(76) Inventors: Brian K. Beesley, Draper, UT (US); Eric Hales, Ogden, UT (US); Claude Brandt, Salt Lake City, UT (US)

Correspondence Address: THORPE NORTH & WESTERN, LLP., 8180 SOUTH 700 EAST, SUITE 200, SANDY, UT, 84070, US

(21) Appl. No.: 11/506,772

(22) Filed: Aug. 11, 2006

Related U.S. Application Data
(60) Provisional application No. 60/709,953, filed on Aug. 18, 2005.

(51) Int. Cl. B01F 15/02; B01F 7/00; B01F 13/00

(52) U.S. Cl. 366/195; 366/206; 134/18

(57) ABSTRACT

A beverage mixer device with a base including a motor to turn a drive mechanism extending from the base. The beverage mixer includes a container, removably disposable on the base. The container has a mixing assembly rotatably disposed in the container and engagable by the drive mechanism when the container is disposed on the base. The container also includes a spigot operatively coupled to the container to dispense contents of the container. A spigot actuator is carried by the base, and a linkage is operatively coupled to the spigot actuator on the base and the spigot to operate the spigot. The spigot actuator is operatively coupled to the motor such that operation of the linkage actuates the motor to turn the mixing assembly in the container.

### PRIORITY CLAIM

Priority of U.S. Provisional Patent Application Ser. No. 60/709,953 filed on Aug. 18, 2005 is claimed; and which is herein incorporated by reference.

### BACKGROUND

1. Field of the Invention

The present invention relates generally to beverage mixers, smoothie makers, blenders, and the like. More particularly, the present invention relates to such a beverage mixer with an automatic dispensing actuator and an improved flow and dripless spigot.

2. Related Art

Frozen, frosty, or icy drinks have become increasingly popular. Such drinks include the traditional shakes, and the more recently popular smoothies. Shakes, or milk shakes, are typically formed of ice-cream and/or milk, and flavored as desired, with or without additives, such as candies, chocolates, peanut butter, etc. Milkshakes typically are available at most fast-food restaurants, such as burger chains, and can be made by special machines, or hand- made using mixers.

Smoothies tend to be healthier, and are formed of ice, frozen yogurt, and/or sorbet, and also can include additives such as fruit, berries, fruit juice, vitamins, etc. Smoothies typically are available from specialty chains or juice bars, and can be made with commercial or restaurant-grade blenders.

Such drinks also can be made at home, using a standard kitchen blender. One disadvantage with making such drinks, or utilizing blenders, is the difficulty in operating the blender, or the inadequacy of the blender. Blenders often get clogged or otherwise stalled by the drink ingredients. It is often necessary to supplement the blending by stirring the ingredients with a spoon or spatula. The spoon or spatula can get caught in the blades of the blender. In addition, using the spoon or spatula often requires removing the lid, thus increasing the chances for the ingredients to be expelled through the top of the container.

In addition, once the blending is completed, it is often necessary to remove the container from the blender and pour the contents into a drinking cup or glass. It will be appreciated that the container has an open top that is substantially larger than a typical drinking cup or glass. Thus, it is common for the contents to pour out of the wider opening of the container, and outside the narrower cup or glass, creating a mess to clean-up, and wasting the contents. In addition, it will be appreciated that the shakes or the smoothies tend to be thick and/or viscous, and thus can be difficult to pour.

A beverage mixer with a spout has been proposed to facilitate dispensing contents. For example, see U.S. Pat. No. 6,527,433. While spouts have been found to facilitate dispensing contents from a container of a beverage mixer, spouts can lead to other problems, such as dripping and erratic spray. Another blender has been developed with a one-hand dispensing mechanism that operates a valve in a spout when engaged by a cup. See the WaveStation™ by Hamilton-Beach. Although such a mechanism allows the spout to be actuated by the hand holding the cup, the other hand often needs to actuate a motor button to assist in dispensing the contents. The further development of beverage mixers is an ongoing endeavor.

### SUMMARY OF THE INVENTION

It has been recognized that it would be advantageous to develop a beverage mixer to facilitate dispensing contents therein. In addition, it has been recognized that it would be advantageous to develop a beverage mixer with improved dispensing characteristics. In addition, it has been recognized that it would be advantageous to develop a beverage mixer with an automatic dispensing actuator. In addition, it has been recognized that it would be advantageous to develop a beverage mixer with improved flow. In addition, it has been recognized that it would be advantageous to develop a beverage mixer with a dripless spigot. Furthermore, it has been recognized that it would be advantageous to develop a beverage mixer with improved mixing characteristics.

The invention provides a beverage mixer device with a base including a motor to turn a drive mechanism extending from the base. The beverage mixer can also include a container, removably disposable on the base. The container can have a mixing assembly rotatably disposed in the container and engagable by the drive mechanism when the container is disposed on the base. The container can also include a spigot operatively coupled to the container to dispense contents of the container. A spigot actuator can be carried by the base, and a linkage can be operatively coupled to the spigot actuator on the base and the spigot to operate the spigot. The spigot actuator can be operatively coupled to the motor such that operation of the linkage actuates the motor to turn the mixing assembly in the container.

In accordance with another aspect of the present invention, the mixing assembly can include a plurality of blades extending radially outward and having a predetermined orientation with respect to one another. The container can include a plurality of ribs protruding into the container that can be positioned circumferentially around the container in a predetermined orientation with respect to one another. The blades and the ribs can be oriented with respect to one another such that only one blade aligns with only one rib at any given rotational orientation of mixing assembly.

In accordance with another aspect of the present invention, the spigot can include a stopper that can be movable between open and closed positions. The stopper can have a distal end and two spaced apart seals circumscribing the distal end. The two spaced apart seals can engage the spigot to restrict fluid flow through the spigot. The spigot can also include a deflector protruding into the channel upstream of the stopper.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a perspective view of a beverage mixer in accordance with an embodiment of the present invention;

FIG. 2 is a cross-sectional side view of the beverage mixer of FIG. 1;

FIG. 3 is an exploded view of the beverage mixer of FIG. 1;

FIG. 4 is a front view of the beverage mixer of FIG. 1;

FIG. 5 is a side view of the beverage mixer of FIG. 1;

FIG. 6 is a top view of the beverage mixer of FIG. 1

FIG. 7 is a perspective view of a base of the beverage mixer of FIG. 1;

FIG. 8 is a cross-sectional side view of the base of FIG. 7;

FIG. 9 is an exploded view of the base of FIG. 7;

FIG. 10 is a cross-sectional top view of the beverage mixer of FIG. 1;

FIG. 11 is an exploded view of a spigot of the beverage mixer of FIG. 1;

FIG. 12 is a cross-sectional side view of the spigot of FIG. 11 with a frustro-conical stopper; and

FIG. 13 is a cross sectional side view of the spigot of FIG. 11 with a truncated frustro-conical stopper;

FIG. 14 is a perspective view of a spigot of the beverage mixer in accordance with another embodiment of the present invention;

FIG. 15 is a cross sectional side view of the spigot of FIG. 11 with a truncated frustro-conical stopper;

FIG. 16 is an cut-away view of a sealing portion of the spigot of FIG. 11; and

FIG. 17 is a back view of the spigot of FIG. 11.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

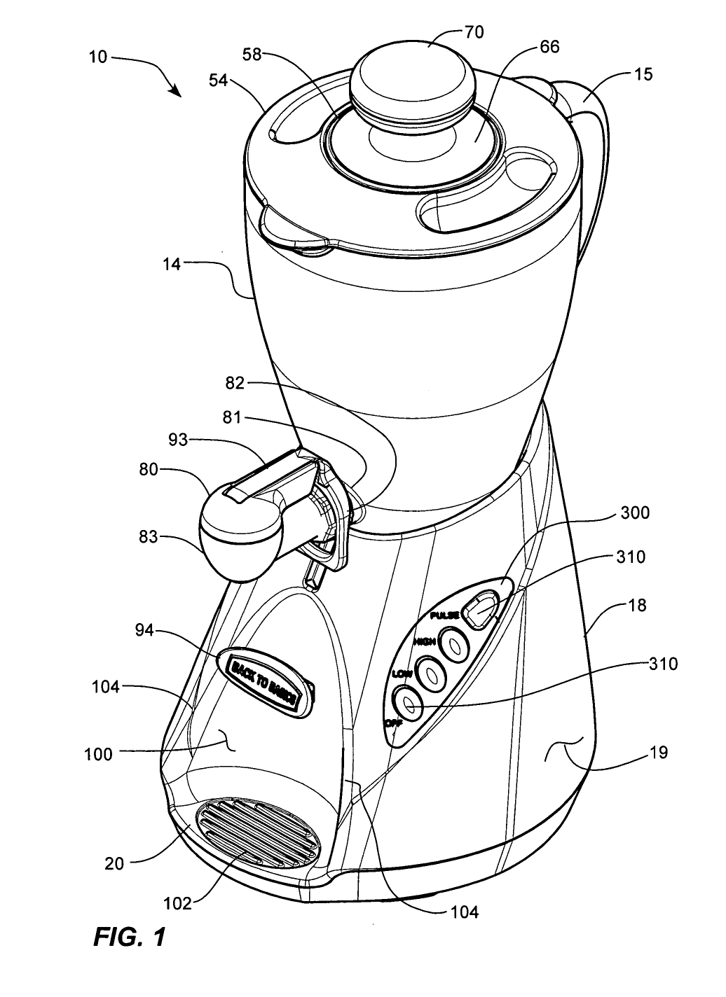

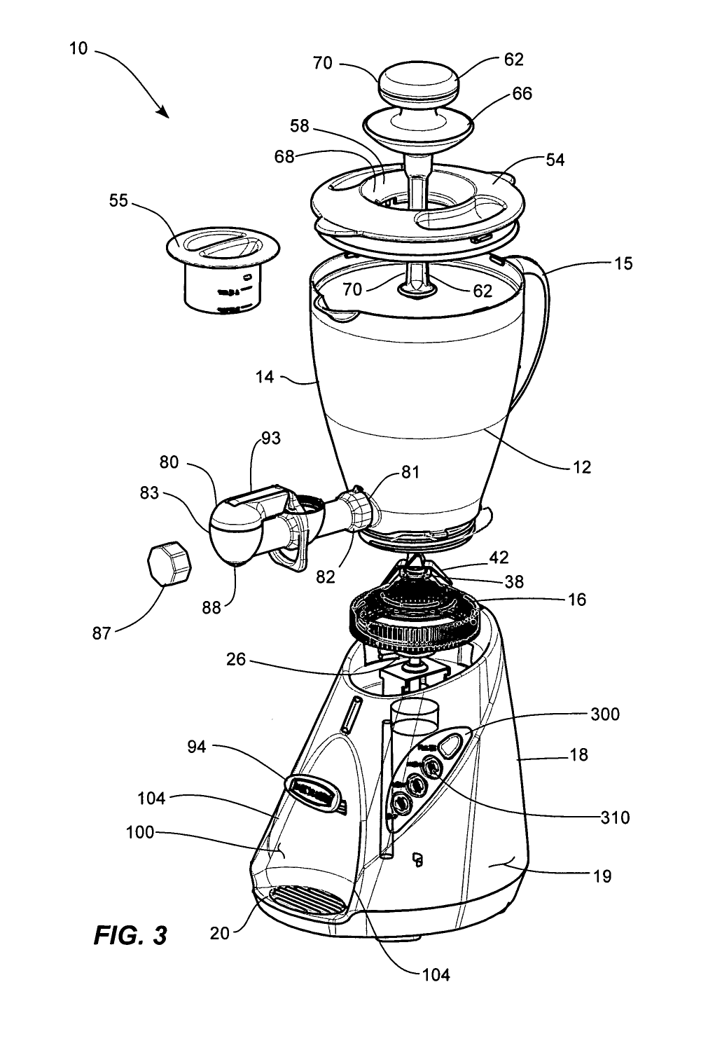

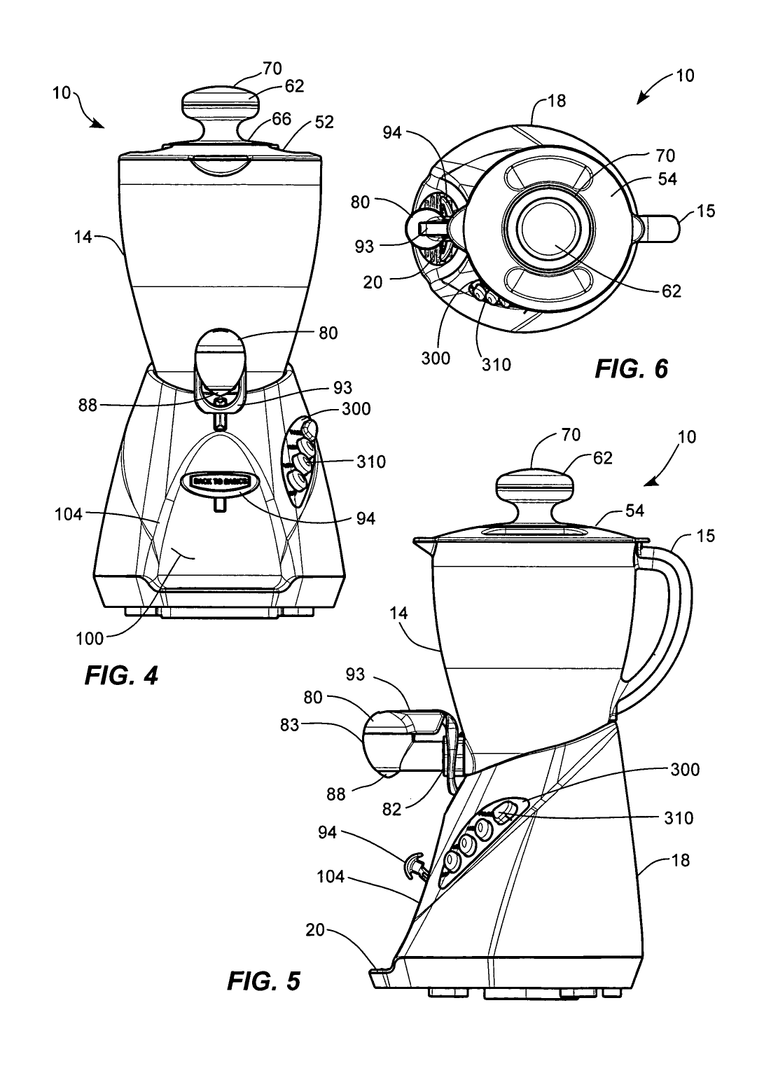

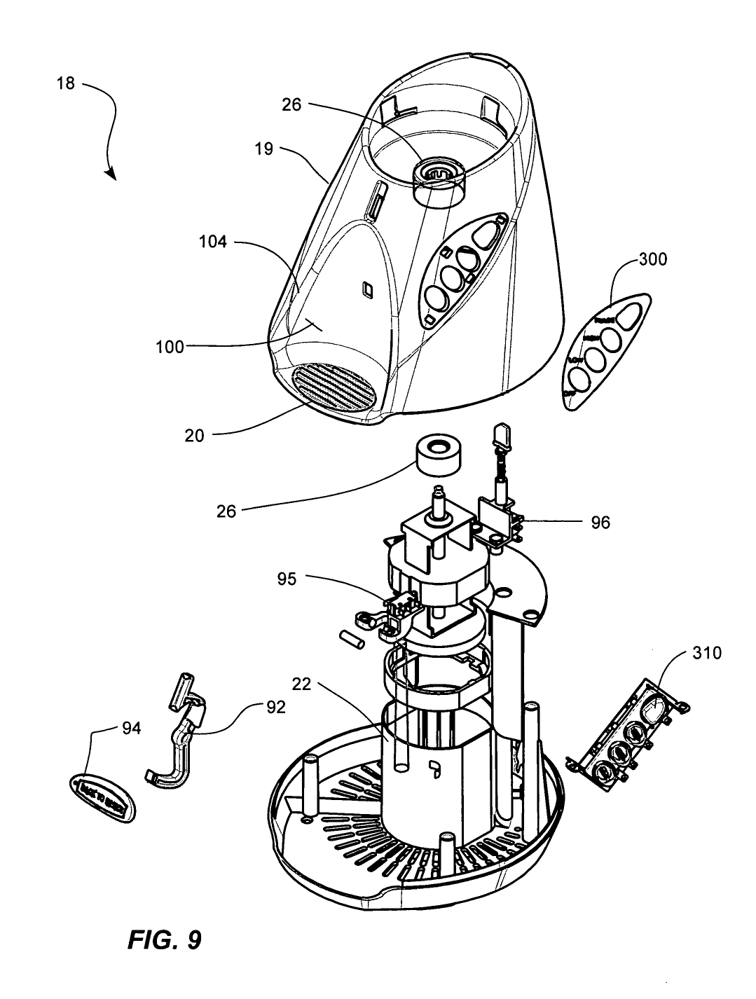

As illustrated in FIGS. 1-12, a beverage mixer, indicated generally at 10, in an example implementation in accordance with the invention is shown. The beverage mixer can be a smoothie maker, blender or the like. The smoothie maker or beverage mixer will be described below and illustrated with respect to a smoothie maker. It is of course understood that the present invention is equally applicable to beverage mixers, blenders, and the like. Smoothies and frozen drinks are examples of a field that may benefit from use of such a smoothie maker.

In accordance with one aspect of the present invention, the beverage mixer has a “single touch” dispensing valve for making smoothies, frozen drinks, or the like. The beverage mixer includes an automatic dispenser that both opens a spigot and actuates a motor to dispense contents of a container through the spigot. In accordance with another aspect of the present invention, the beverage mixer has a spigot with improved flow characteristics. In accordance with another aspect of the present invention, the beverage mixer has a dripless spigot. In accordance with another aspect of the present invention, the beverage mixer has a container and mixer configuration to improve mixing characteristics.

Referring to FIGS. 1-6, the beverage mixer 10 can include a container or jar 14 removably disposable on a base or housing 18. Thus, the container 14 can be removed from the base 18 for cleaning, etc., while the base can include electrical components and the like. The base 18 can include a motor 22 capable of turning a drive mechanism 26 that extends from the base 18. In one aspect, the drive mechanism 26 can be located at a top of the base 18, and the container 14 can be disposable on the top of the base 18, and on top of the drive mechanism 26. Thus, the container 14 can utilize gravity to help maintain the container 14 on the base 18.

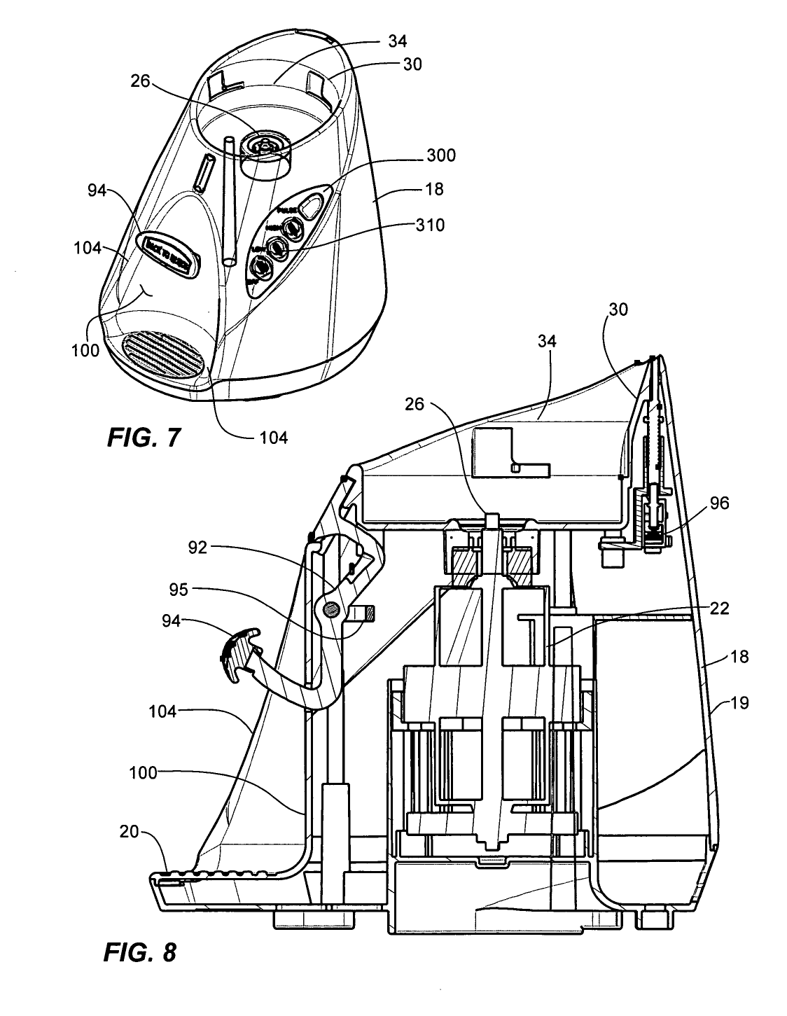

The base 18 can include a receptacle or socket for supporting the container 14, as shown in FIGS. 7-9. The receptacle or socket 30 can be formed with the base 18 and configured to receive the container 14, or a portion thereof. The receptacle 30 can be formed on the top of the base 18 with the drive mechanism 26 disposed within the receptacle 30. The receptacle 30 can include a perimeter wall 34 to receive the container 14, or portion thereof, therein. Alternatively, the container 14 can fit over and around the perimeter wall 34 such that the container can receive the perimeter wall. In one aspect, the receptacle 30 can be circular, and the perimeter wall 34 can be an annular wall. Additionally, the base 18 and the container 14 can be formed as a single unit such that the container cannot be removed from the base.

Returning to FIGS. 1-6, the container 14 can include a mixing assembly 38 that can include a plurality of blades 42 rotatably disposed in the container 14. The mixing assembly 38 can be engaged by the drive mechanism 26 of the base 18 when the container 14 is disposed on the base 18, or in the receptacle 30. For example, the drive mechanism 26 and the mixing assembly 38 can include mating or matching couplings, such as one or more intermeshing protrusions and indentations, so that the rotation and force of the motor 22 in the base can be transferred to the mixing assembly 38 or blades 42 in the container 14. A lower portion or bottom of the container 14 can be configured to mate or match the receptacle 30 to help maintain the container 14 on the base 18, and to properly align the mixing assembly 38 of the container 14 with the drive mechanism 26 of the base 18, or couplings thereof. Thus, the lower portion or bottom of the container 14 can be circular to match the circular shape of the receptacle 30.

The container 14 can include a base or bottom portion 16 secured to a container portion 12. The base or bottom portion 16 can be circular to match the circular shape of the receptacle 30 as described above. The base portion 16 of the container 14 can be removably secured to the container portion 12, such as by screw threads, so that the container 14 can be disassembled for cleaning. In addition, the mixing assembly 38 can be secured to the container 14 by the base portion 16, or between the base portion and the container portion 12. Thus, the mixing assembly 38 also can be removably secured to the container 14. The mixing assembly 38 can cooperate with the base portion 16 to engage the drive mechanism 26 of the base 18.

The container portion 12 can be a hollow shell with an annular wall to receive ingredients therein. In addition, the container portion 12 or shell or wall can be transparent, or formed of a transparent material, to enable viewing the contents of the container 14. A top of the shell or container 14 can be open to receive ingredients therethrough, while the bottom of the shell can be open to receive the mixing assembly 38 so that the mixing assembly 38 or blades 42 can operatively engage the contents of the container 14. The base portion 16 can be configured as a cup to receive a bottom portion of the container portion or shell therein, and to enclose the bottom of the container 14. Thus, the base portion 16 and container portion 12 can form the container 14.

A lid 54 can be removably disposed on the container 14 to resist expulsion of the contents or the ingredients in the container during mixing, or while the blades 42 are rotating. The lid 54 can include an opening 58 therethrough. Thus, ingredients can be introduced into the container 14 either by removing the lid 54 and inserting the ingredients into the container 14, or by inserting the ingredients through the opening 58 in the lid.

A stir stick 62 is configured to be carried by the lid 54, and to cooperate with the lid 54, to allow the contents of the container 14 to be stirred with the stir stick 62, and/or to cover the opening 58 of the lid 54. The stir stick 62 can be extendable through the opening 58 in the lid 54 and into the container 14. In addition, the stir stick 62 can be pivotable with respect to the lid 54.

The stir stick 62 includes a bulbous or ball portion 66 pivotally disposable over the opening 58 of the lid 54. The lid 54 can include a conical or rounded indentation or socket 68 surrounding the opening 58 to receive the ball portion 66 of the stir stick 62. The ball portion 66 cooperates with the lid 54 to cover the opening 58 and to allow the ball portion 66 to pivot in the opening 58. Thus, the ball portion 66 of the stir stick 62 and the opening 58 in the lid 54 form a ball-and-socket type coupling. The ball portion 66 has a bulbous, spherical, semi- spherical, or rounded shape that slides smoothly in the opening 58 of the lid 54 as the stir stick 62 pivots in the container 14. In addition, the ball portion 66 limits the distance the stir stick 62 can be inserted into the container 14 to resist contact between the stir stick 62 and the mixing assembly 38 or blades 42. The lid 54 or opening 58 can be configured to match or mate with the ball portion 66.

The stir stick 62 also can include a handle portion 70 and a stir portion 74. The handle portion 70 is configured to extend above the lid 54, while the stir portion 74 is configured to extend below the lid 54, and into the container 14. The handle portion 70 can be configured to facilitate grasping. In one aspect, the handle portion 70 can have a bulbous, circular, or spherical shape that can be grasped by a user's hand.

The stir portion 74 can have a length that extends to a location above the mixing assembly 38 or blades 42, but without contacting the blades 42, to prevent damage. The length of the stir portion 74 and the ball portion 66 captured in the opening 58 of the lid 58 prevent the stir stick from reaching and interfering with the mixing assembly 38.

The stir stick 62 can be removable from the lid 54 and the container 14 to facilitate cleaning the stir stick, the lid, and the container. When the stir stick 62 is removed from the lid 54, a lid cap 55 can be placed into lid opening 58 to close the opening.

A spigot or spout 80 is operatively coupled to the container 14 at or near the bottom of the container 14. The spout 80 advantageously allows the contents of the container 14 to be dispensed through the spout 80, as opposed to being poured through the top of the container. The container 14 or base portion 12 can have an opening 81, with a proximal end 82 of the spout coupled to the container or base portion at the opening. The spout 80 can form a fluid channel through with the contents of the container flow to be dispensed. The spout 80 can include any type of valve and/or actuation system. For example, the spout 80 can have a plunger type valve or stopper 88 within the spout 80. The stopper 88 can be displaced between open and closed positions. The spout 80 can include an outlet opening 90 positioned at the distal end 83. The spout 80 extends outwardly and away from the container 14, to a position beyond a perimeter of the base so that the contents can be dispensed while the container remains on the base.

The spout 80 can be removable from the container to facilitate cleaning the container and the spout. When the spout 80 is removed from the container, a cap 87 can be placed over outlet opening 90 to close the opening.

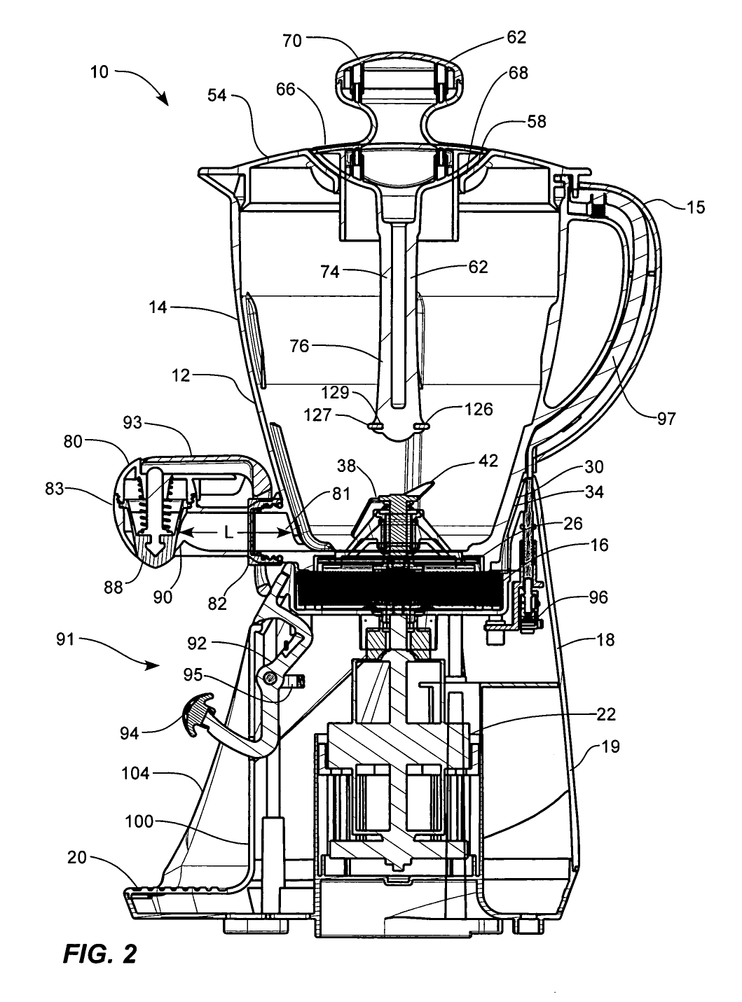

As described above, the device 10 can include an automatic dispenser that operates when a cup is placed underneath the spigot 80. A linkage, indicated generally at 91 (FIG. 2), can be coupled to the base 18 and to the spigot or stopper 88. For example, the linkage can include a base linkage or arm 92 pivotally coupled to the base 18 and a spigot linkage or lever 93 carried by the spigot. An actuator 94 can be disposed on the arm 92 and can extend from the base. The actuator 94 can be engaged by a cup to displace or pivot the arm 92, which in turn displaces or pivots the lever 93, which in turn lifts the stopper 88. The arm 92 can be carried by the base while the lever 93 can be carried by the container such that they are separate and can be moved independently when the container 14 is removed from the base 18. In addition, the linkage 91 or arm 92 can be operatively coupled to the motor 22, such as by an electrical switch 95 or button, such that the motor is operated and the mixing assembly rotated when the actuator 94 is engaged to facilitate dispensing of the contents.

Furthermore, a safety switch 96 can be disposed on the base 18 to detect the presence of the container 14 and the lid 54 before the motor 22 is operable. For example, a safety rod 97 or the like can extend through the container 14 or handle 15 thereof from the top adjacent the lid 54 to the bottom adjacent the safety switch 96. When the lid 54 is disposed on the container 14 it will depress the rod 97 which in turn will engage the safety switch 96 when the container 14 is one the base 18.

The container 14 and base 18 advantageously are configured to facilitate dispensing the contents of the container 14 through the spout 80. As described above, the contents of the container, such as a smoothie or milk shake, can be thick or viscous, and thus difficult to dispense by pouring out of the top of the container. While the spout 80 can facilitate dispensing the contents, it will be appreciated that it can be difficult for the thick or viscous contents to flow through the spout. The longer the spout, the more friction is developed between the contents and the spout. Thus, the spout 80 can have a length L that is minimized. While the spout 80 should have a length that extends beyond the base 14 in order to pour, it has been recognized that the base 18 itself can be configured to reduce the length of the spout, and thus reduce the frictional losses associated with the flow of the contents through the spout.

Accordingly, the base 18 can include an indentation configuration with a beverage cup accommodation indentation 100. The indentation 100 is positioned under the outlet opening 90 of the spout 80 so that when the container 14 is disposed on the base 18, a beverage cup can be more conveniently placed in the indentation 100 and under the spout 80. The indentation 100 advantageously extends into the base 18 to reduce the length L of the spout 80, and thus reduces frictional loses of contents flowing through the spout.

The base 18 can include a perimeter base wall 19 extending around and defining a perimeter of the base 18. The indentation 100 can be formed in a perimeter 19 of the base 18 by the perimeter base wall 19. The indentation 100 can extend horizontally into the base 18, and can be formed by a vertically oriented portion of the perimeter base wall. The vertically oriented portion of the perimeter base wall extends from a top of the indentation 100 proximate the spout 80 when the container 14 is disposed on the base, to a bottom of the indentation 100 proximate a bottom of the base. A portion 20 of the base can extend under the cup indentation to form a drip plate 102. The actuator 94 can be disposed in the cup indentation 100.

One or more protrusion 104 can extend horizontally outward from the base 18 adjacent the indentation 100. Thus, the indentation 100 can be disposed between, and defined by, protrusions 104 on either side. The protrusions 104 can be formed in the base 14 to properly position a cup or glass under the spout 80 to resist spills.

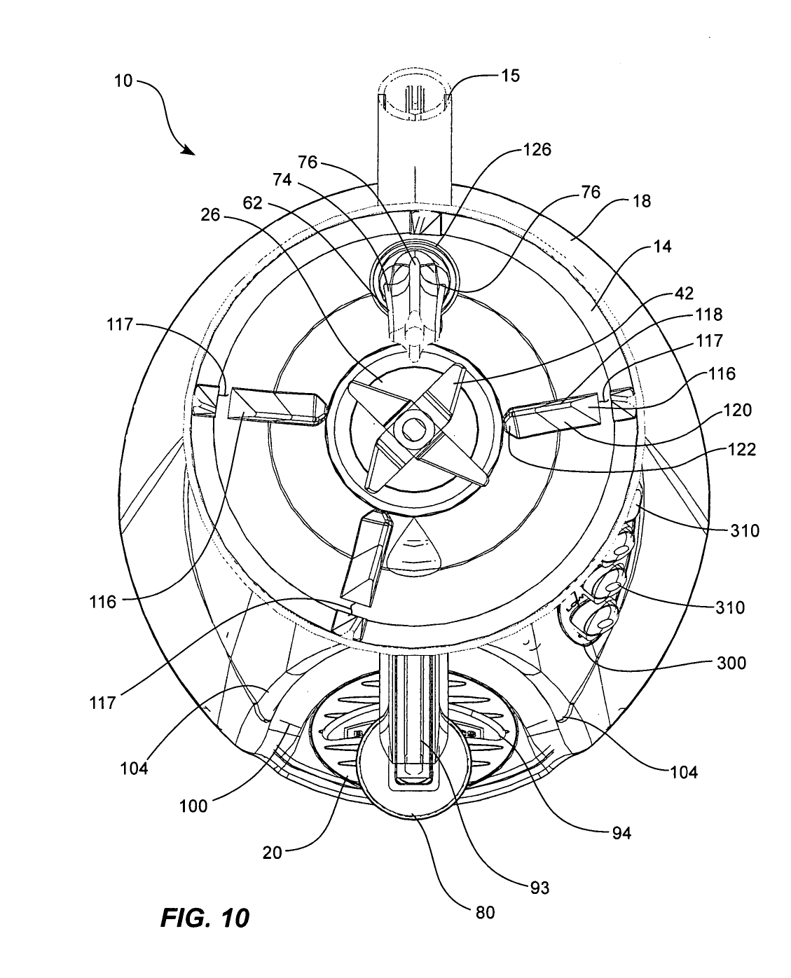

Referring to FIG. 10, protrusions or ribs 116 can extend inwardly from the wall of the container 14 to facilitate mixing or blending. The ribs 116 and blades 42 can be configured and oriented such that only one blade aligns with only one rib at any given rotational orientation of the mixing assembly. For example, the blades can be oriented at 90 degrees with respect to one another, while the ribs are oriented at 15, 80, 180 and 265 degrees. It will be appreciated that the ribs can have the 90 degree orientation while the blades have the 15, 80, 180 and 265 degree orientation. It will also be appreciated that other angular orientations are possible. The orientation of the blades 42 with respect to the ribs 116 is believed to prevent pulsating load on the motor and coupling, and to allow the device to operate more quietly.

The ribs 116 can also have a non-symmetrical configuration. The ribs 116 can have a horizontal cross-sectional that is non-symmetrical with respect to a radial orientation. For example, the ribs 116 can have a horizontal cross-sectional with a more radially aligned wall 118 on an upstream side to abut to a direction of flow and a more angled wall 120 forming a greater angle with respect to a radial direction on a trailing or downstream side. It is believed that such a configuration promotes a vertical vortex that facilitates mixing.

Furthermore, the ribs 116 can have a horizontally extending portion 122 at a bottom of the container. This is believed to facilitate mixing at the blades. The horizontal portion 122 extends radially inwardly towards the blades along the bottom of the container.

Referring to FIGS. 2 and 10, the stirring portion 74 of the stir stick 62 can also be configured to facilitate stirring or mixing. The stirring portion 74 can be selectively manipulated or pivoted by the user to stir or mix the ingredients. In one aspect, the stirring portion 74 can include broad or wide fins 76, similar to a spatula, to push or move the ingredients as the stirring portion 74 is pivoted. In another aspect, the stirring portion 74 can include at least two fins 76 extending therefrom in transverse directions to a longitudinal axis of the stirring portion 74, and in transverse directions to one another, to facilitate stirring and mixing. Thus, the stirring portion 74 can have a cross section in the shape of a cross (“x”) or plus (“+”) shape so that as the stirring portion 74 is pivoted in a circular direction, a broad surface of at least one of the fins 76 will push against the ingredients.

A bumper 126 can be located on a lower end of the stir stick 62 to contact the inner surface or wall of the container 14 as the stir stick is pivoted. The bumper 126 can be formed of a flexible material to resist marring the container. It will be appreciated that repeated contact between two objects, such as the stir stick 62 and container 14, can result in marring, and that can be unsightly, especially with a transparent or translucent container. Thus, as the user stirs the ingredients in the container 14 with the stir stick 62, the lower end may often strike the wall of the container 14, but the bumper 126 will resist marring. In one aspect, the bumper can be an o-ring 127. An annular indentation or groove 129 can be formed in the lower end of the stir stick 62 or stirring portion 74 to receive the o-ring or bumper. The o-ring or bumper can surround the lower end of the stirring portion 74. Breaks 117 can be formed in the ribs 116 of the container to allow the stir stick to completely pivot about the inside of the container 14.

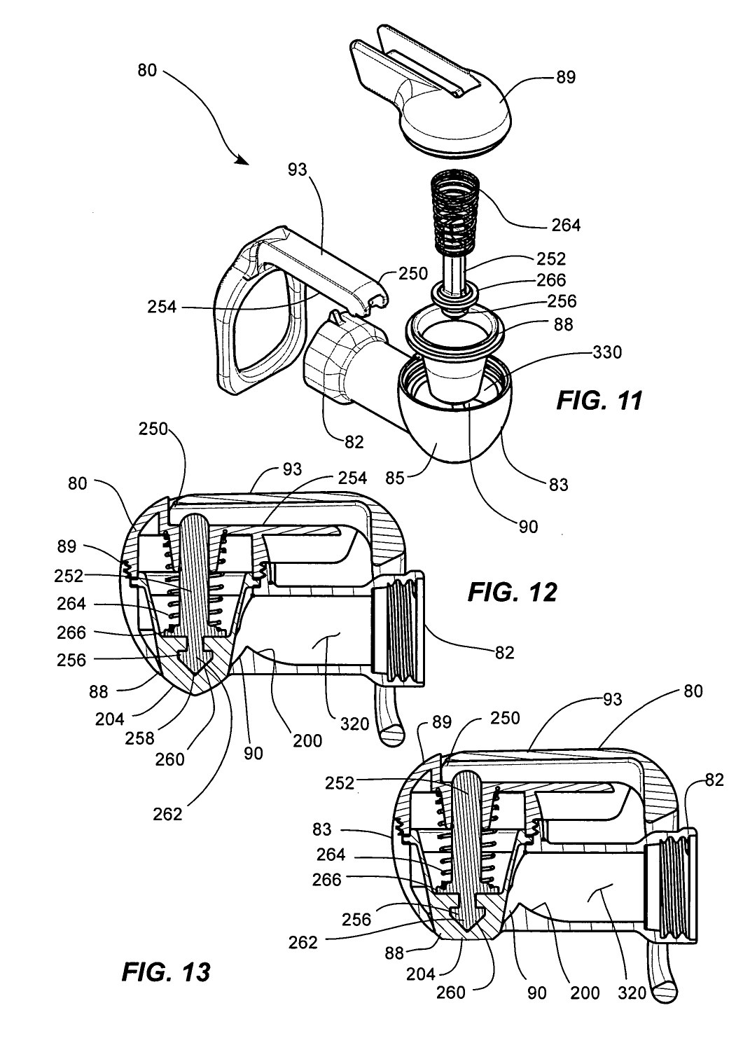

Referring to FIGS. 11-13, the spigot 80 and/or stopper 88 can be configured to facilitate flow. The spigot 80 can have a horizontal channel 320 extending from the opening 81 in the container 14 toward the distal end 83 of the spigot. At the distal end 83 of the spigot 80, a vertical chute 330 can extend from the horizontal channel to the outlet opening 90.

A plunger, or stopper 88, can be movably disposed in the vertical chute 330 and can be movable between an open position and closed position. In the open position, the contents of the container 14 can flow through the horizontal channel 320 into the vertical chute 330 and out the outlet opening 90. In the closed position, the stopper 88 can block the outlet opening 90 and prevent the release of the contents of the container 14. The stopper can be formed of a flexible elastomeric material that can elastically conform to the shape of the spigot 80 when the stopper 88 is in the closed position to seal the outlet opening of the spigot.

The stopper 88 can be moved between the open and closed positions by the lever 93. Lever 93 can be coupled at a distal end 250 to a retraction rod 252 that can be pulled upward as the lever 93 is moved by the actuator 94. The bottom surface 254 of the lever 93 can include a flat portion 255 that can act as a cam against the lid 89 of the spigot 80 so that as the lever 93 is moved by the actuator 94 the flat portion or cam 255 pushes against the lid 89 and pulls the retraction rod 252 upward.

The retraction rod 252 can have a protrusion 256 on a distal end 258. The protrusion can fit within a cavity 260 of the stopper 88. The cavity 260 of the stopper can have an opening 262 that can be sized and shaped smaller that the size and shape of the protrusion 256. Because the stopper 80 can be formed from a flexible elastomeric material the opening 262 in the stopper can be pulled or stretched to a larger size to fit around the protrusion 256 and allow the protrusion to be fit within the cavity 260. With the protrusion positioned within the cavity 260 the opening can close around the retraction rod 252 above the protrusion 260 and resist movement of the protrusion away from the cavity. In this way, movement of the retraction rod 252 can result in moving the stopper between the closed and open positions.

Additionally, the stopper 88 can be biased to the closed position so that the spigot 80 outlet opening 90 is blocked or sealed until a user desires to open the spigot to dispense the contents of the container. For example, a spring 264 can be disposed on the retraction rod 252 and can push against a spigot top or lid 89 and a reaction ring 266 on the retraction rod 252 in order to push the retraction rod and the stopper 88 down into the closed position.

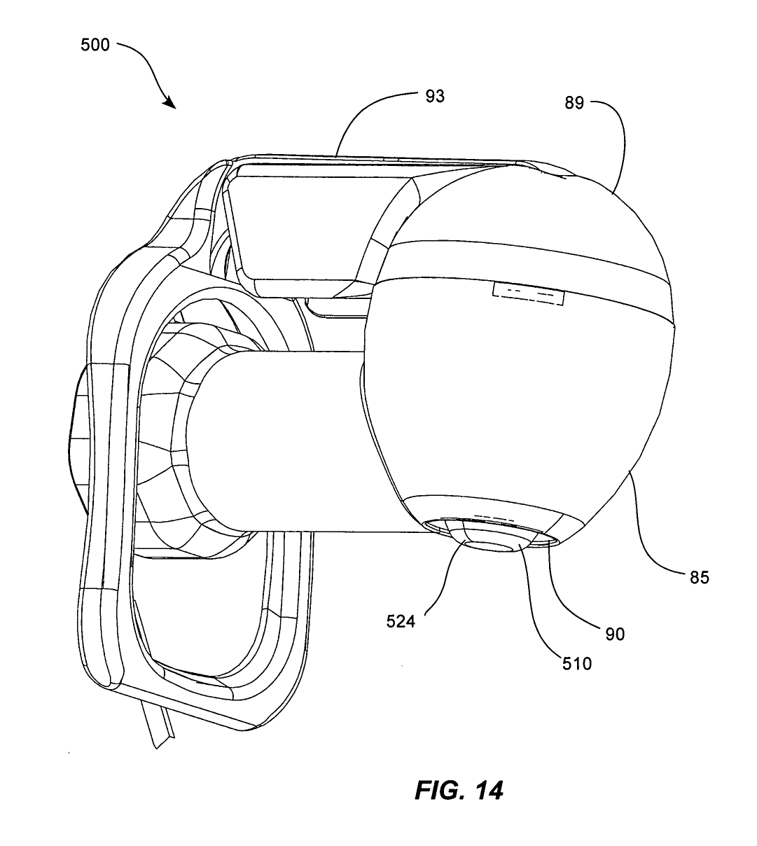

A deflector 200 can be disposed in the spigot 80 upstream of the stopper 88 to facilitate flow straight down through the opening 90. Without the deflector 200, it has been found that contents explode, or exit from the opening with considerable force. In addition, the stopper 88 can have a convex shape to facilitate converging flow at the opening 90. For example, the stopper 88 can have a conical, frustro-conical, spherical, or hemispherically shaped end 204 to shed liquid and reduce the possibility of dripping from the outlet opening 90 after the stopper is moved to the closed position. In one aspect, the stopper 88 can have a frustro-conically shaped end 204 with the cone pointing in a downward direction, as shown in FIG. 12. In another aspect, the stopper can have a flattened frustro-conical shape in that the cone can be truncated or cut off before reaching a pointed end, as shown in FIG. 13. In addition, the stopper 88 can have the lower end 204 that extends through the opening 90 in a closed configuration to allow wiping of the stopper to clean the stopper and the spigot 80.

Returning to FIGS. 1-6, controls or a control panel 300 with buttons 310 for controlling the operation of the motor 18 or smoothie maker 10 also can be disposed on the base 18. As is known in the art, the controls or buttons 310 can be electrically coupled to the motor 22 to control its operation. The buttons 310 can include an on/off button, speed control, and the like.

In operation the lid 54 can be removed from the container 14 and ingredients for a smoothie or other frozen drink placed within the container 14. Alternatively, the lid 54 can remain on the container 14, and the ingredients can be inserted through the opening 58 of the lid 54, with the stir stick 70 removed therefrom. The container 14 may be disposed on the base 18 before the ingredients are placed in the container 14, or after. The mixing assembly 38 may be actuated, by operating the motor 22, in order to blend the ingredients within the container 14. In addition, a user may grasp the handle portion 70 of the stir stick 62, and pivot or rotate the stir stick, such that the stirring portion 74 of the stir stick facilitates moving and mixing the ingredients in the container 14. After the ingredients or contents are blended, a glass or cup may be placed under the spout 80, and in the cup or glass indentation 100. The cup can engage the actuator 94 causing the spigot to open and the motor to operate to dispense contents from the container 14, through the spout 80, and into the cup or glass.

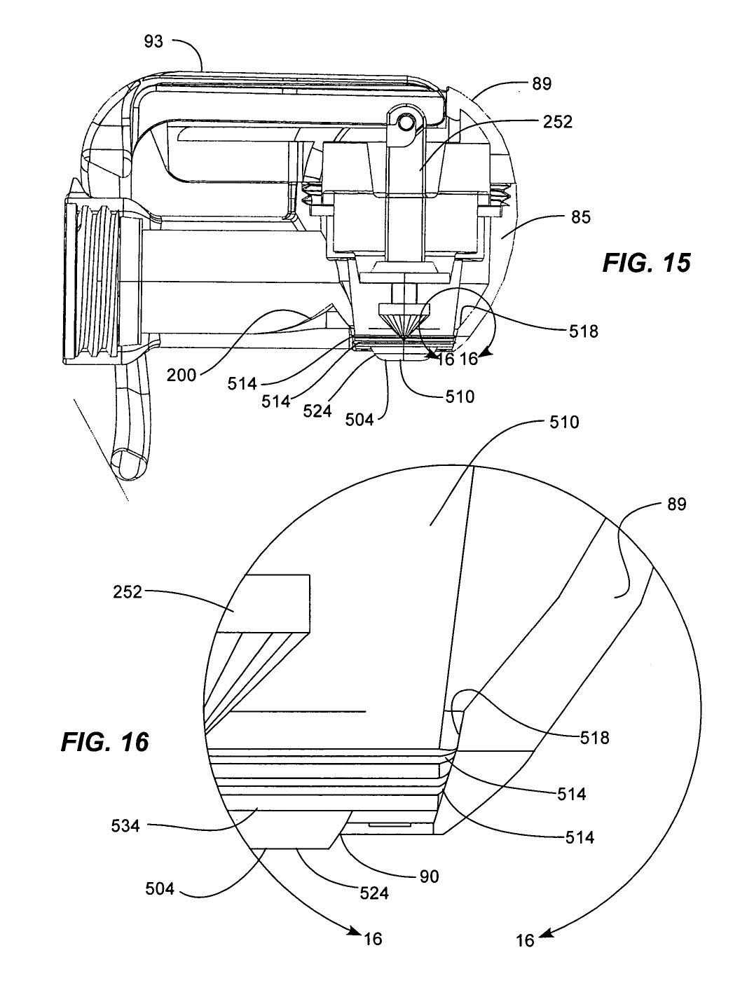

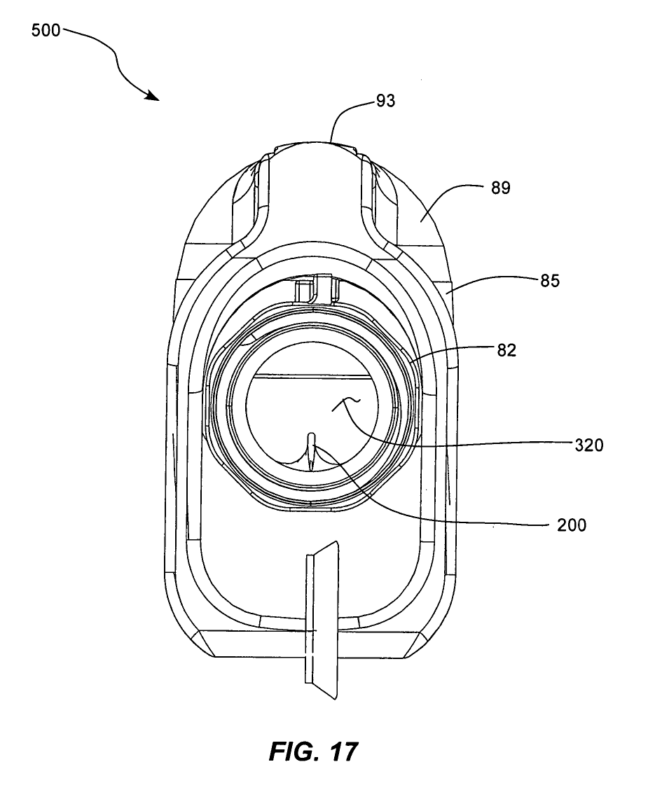

As illustrated in FIGS. 14-17, a spigot 500 is shown in accordance with another embodiment of the present invention for use with the beverage mixer 10. The spigot 500 is similar in many respects to the spigot 80 described above and shown in FIGS. 1-13. The spigot 500 can have a spigot body 85, a lid 89 and a lever 93 coupled to a retraction rod 252.

The spigot 500 can also have a stopper 510 that can be moved between an open position and a closed position. Additionally, the stopper 510 can provide a seal against the spigot 500 when the stopper is in the closed position. For example, the stopper 510 can have two spaced apart seals 514 that can circumscribe the distal end 504 of the stopper 510. The seals 514 can be engageable with an inner side 518 of the spigot body 85 to restrict fluid flow through the spigot.

It will be appreciated that the stopper 510 could have a single seal or more than two seals to perform the sealing function with the spigot body 85. The two seal configuration has been found to provide an advantageous redundancy in the circumstance that a piece of ice or other hard material should become lodged between the stopper 510 and the spigot 500 at the location of one of the seals. In this circumstance, the other seal 514 can provide an adequate seal and restrict fluid flow through the spigot.

Additionally, a distal surface 534 of the stopper 510 can engage the spigot body 85 or the outlet opening 90 to form a tertiary seal with the spigot 500 in order to restrict fluid flow through the outlet opening 90. In this way, the two spaced apart seals 514 and the distal surface 534 of the stopper 510 can form three spaced apart circumferential contacts with the spigot 500 or spigot body 85 when the stopper 510 is in the closed position. Thus, in the event that a foreign body, such as ice, fruit, seed, or other hard material should become positioned between the stopper 510 and the spigot body 85 at the location of both of the seals 514, the distal surface 534 of the stopper 510 can still restrict fluid flow through the spigot 500.

The stopper 510 can include, or be formed of a flexible elastomeric material, and the two spaced apart seals 514 can be conformable to the shape of the inside wall 518 of the spigot to seal against the spigot when the stopper is in the closed position, as shown in FIG. 16. Additionally, the flexible elastic material can allow the stopper 510 to deform when the retraction rod 252 pulls the stopper upward and into the open position.

The distal end of the stopper 504 can also have a convex shape to facilitate converging flow at the opening 90. For example, the convex shape can be a truncated frustro-conical protrusion 524 that can be curved to direct dripping material to the truncated portion of the frustro-conical shape. In this way, dripping material from the container can be minimized and directed to the center of flow from the spigot in order to control the drip zone under the spigot.

Various aspects of a beverage mixer are described in U.S. Pat No. 6,527,433; and U.S. patent application Ser. No. 10/278,731 filed Oct. 23, 2002, and U.S. patent application Ser. No. 10/959,491 filed Oct. 4, 2004; all of which are herein incorporated by reference.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A beverage mixer device, comprising:
a) a base including a motor to turn a drive mechanism extending therefrom;
b) a container, removably disposable on the base, including a mixing assembly rotatably disposed therein and engagable by the drive mechanism when the container is disposed on the base;
c) a spigot, operatively coupled to the container to dispense contents thereof;
d) a spigot actuator carried by the base;
e) a linkage operatively coupled to the spigot actuator on the base and the spigot to operate the spigot; and
f) the spigot actuator being operatively coupled to the motor such that operation of the linkage actuates the motor.

2. A device in accordance with claim 1, further comprising:
a cup indentation formed in the base under the spigot when the container is disposed on the base, and defined between lateral protrusions of the base extending on either side of the cup indentation; and
the valve actuator disposed in the cup indentation and contactable by a cup inserted into the cup indentation.

3. A device in accordance with claim 1, wherein the spigot further comprises:
a horizontal channel extending from an opening in the container;
a vertical chute extending from the horizontal channel to an outlet opening;
a plunger, movably disposed in the chute between an open position and a closed position; and
a deflector protruding into the channel upstream of the stopper.

4. A device in accordance with claim 1, wherein the spigot further comprises:
a stopper having a distal end at an outlet opening of the spigot and two spaced apart seals circumscribing the distal end, the two spaced apart seals being engageable with the spigot to restrict fluid flow through the spigot.

5. A device in accordance with claim 4, wherein the distal end of the stopper engages the spigot to form a tertiary seal to restrict fluid flow through the outlet opening.

6. A device in accordance with claim 1, wherein the spigot further comprises:
a stopper having a lower end that extends through an outlet opening in the spigot when the stopper is in a closed position.

7. A device in accordance with claim 1, wherein the mixing assembly includes a plurality of blades extending radially outward and having a predetermined orientation with respect to one another;
the container includes a plurality of ribs protruding into the container positioned circumferentially around the container and having a predetermined orientation with respect to one another; and
the blades and the ribs being oriented with respect to one another such that only one blade aligns with only one rib at any given rotational orientation of mixing assembly.

8. A device in accordance with claim 7, wherein the blades are oriented at 90 degrees with respect to one another; and wherein the ribs are oriented at 15, 80, 180 and 265 degrees.

9. A device in accordance with claim 1, further comprising:
at least one rib protruding into the container and oriented substantially vertically; and
the rib having a horizontal cross-sectional that is non-symmetrical with respect to a radial orientation.

10. A device in accordance with claim 1, further comprising:
at least one rib protruding into the container and oriented substantially vertically; and
the rib having a horizontal cross-sectional with a more radially aligned wall on an upstream side to abut to a direction of flow and a more angled wall forming a greater angle with respect to a radial direction on a downstream side.

11. A beverage mixer device, comprising:
a) a base including a motor to turn a drive mechanism extending therefrom;
b) a container, disposable on the base, including a mixing assembly rotatably disposed therein and engagable by the drive mechanism when the container is disposed on the base;
c) a plurality of blades extending radially outward from the mixing assembly and having a predetermined orientation with respect to one another;
d) a plurality of ribs protruding into the container positioned circumferentially around the container and having a predetermined orientation with respect to one another; and
e) the blades and the ribs being oriented with respect to one another such that only one blade aligns with only one rib at any given rotational orientation of mixing assembly.

12. A device in accordance with claim 11, wherein the blades are oriented at 90 degrees with respect to one another; and wherein the ribs are oriented at 15, 80, 180 and 265 degrees.

13. A device in accordance with claim 11, further comprising:
at least one of the ribs having a horizontal cross-sectional that is non-symmetrical with respect to a radial orientation.

14. A device in accordance with claim 11, further comprising:
at least one of the ribs having a horizontal cross-sectional with a more radially aligned wall on an upstream side to abut to a direction of flow and a more angled wall forming a greater angle with respect to a radial direction on a downstream side.

15. A device in accordance with claim 11, further comprising:
a spigot, operatively coupled to the container to dispense contents thereof;
a spigot actuator carried by the base;
a linkage operatively coupled to the spigot actuator on the base and the spigot to operate the spigot; and
the spigot actuator being operatively coupled to the motor such that operation of the linkage actuates the motor.

16. A device in accordance with claim 15, further comprising:
a cup indentation formed in the base under the spigot when the container is disposed on the base, and defined between lateral protrusions of the base extending on either side of the cup indentation; and
the valve actuator disposed in the cup indentation and contactable by a cup inserted into the cup indentation.

17. A device in accordance with claim 15, wherein the spigot further comprises:
a horizontal channel extending from an opening in the container;
a vertical chute extending from the horizontal channel to an outlet opening;
a plunger, movably disposed in the chute between an open position and a closed position;
a deflector protruding into the channel upstream of the stopper.

18. A device in accordance with claim 15, wherein the spigot further comprises:
a stopper having a distal end at an outlet opening of the spigot and two spaced apart seals circumscribing the distal end, the two spaced apart seals being engageable with the spigot to restrict fluid flow through the spigot.

19. A device in accordance with claim 18, wherein the distal end of the stopper engages the spigot to form a tertiary seal to restrict fluid flow through the outlet opening.

20. A device in accordance with claim 15, wherein the spigot further comprises:
a stopper having a lower end that extends through an outlet opening in the spigot when the stopper is in a closed position.

21. A beverage mixer device, comprising:
a) a base including a motor to turn a drive mechanism extending therefrom;
b) a container, disposable on the base, including a mixing assembly rotatably disposed therein and engagable by the drive mechanism when the container is disposed on the base;
c) a spigot, operatively coupled to the container to dispense contents thereof and having an outlet opening; and
d) a stopper disposed in the spigot and movable between open and closed positions; and
e) the stopper having two spaced apart seals circumscribing a distal end of the stopper and engageable with the spigot to restrict fluid flow through the spigot.

22. A device in accordance with claim 21, wherein the distal end of the stopper engages the spigot to form a tertiary seal to restrict fluid flow through the outlet opening.

23. A device in accordance with claim 22, wherein the two spaced apart seals and the distal end of the stopper form three spaced apart circumferential contacts with the spigot when the stopper is in the closed position.

24. A device in accordance with claim 21, wherein the stopper includes a flexible elastomeric material and the two spaced apart seals are conformable to the shape of the spigot to seal against the spigot when the stopper is in the closed position.

25. A device in accordance with claim 21, wherein the spigot further comprises:
a horizontal channel extending from an opening in the container;
a vertical chute extending from the horizontal channel to an outlet opening;
the plunger being movably disposed in the chute between the open position and the closed position; and
a deflector protruding into the channel upstream of the stopper.

26. A device in accordance with claim 21, wherein the stopper has a lower end that extends through the outlet opening in the spigot when the stopper is in the closed position.

27. A device in accordance with claim 21, further comprising:
a spigot actuator carried by the base;
a linkage operatively coupled to the spigot actuator on the base and the spigot to operate the spigot; and
the spigot actuator being operatively coupled to the motor such that operation of the linkage actuates the motor.

28. A device in accordance with claim 27, further comprising:
a cup indentation formed in the base under the spigot when the container is disposed on the base, and defined between lateral protrusions of the base extending on either side of the cup indentation; and
the valve actuator disposed in the cup indentation and contactable by a cup inserted into the cup indentation.

29. A device in accordance with claim 27, wherein
the mixing assembly includes a plurality of blades extending radially outward and having a predetermined orientation with respect to one another;
the container includes a plurality of ribs protruding into the container positioned circumferentially around the container and having a predetermined orientation with respect to one another; and
the blades and the ribs being oriented with respect to one another such that only one blade aligns with only one rib at any given rotational orientation of mixing assembly.

30. A device in accordance with claim 27, wherein the blades are oriented at 90 degrees with respect to one another; and wherein the ribs are oriented at 15, 80, 180 and 265 degrees.

31. A device in accordance with claim 27, further comprising:
at least one rib protruding into the container and oriented substantially vertically; and
the rib having a horizontal cross-sectional that is non-symmetrical with respect to a radial orientation.

32. A device in accordance with claim 27, further comprising:
at least one rib protruding into the container and oriented substantially vertically; and
the rib having a horizontal cross-sectional with a more radially aligned wall on an upstream side to abut to a direction of flow and a more angled wall forming a greater angle with respect to a radial direction on a downstream side.
